(19) United States
(12) Patent Application Publication
(10) Pub. No.: US 2007/0137116 A1
(43) Pub. Date: Jun. 21, 2007

(54) Malco wind-load fastener

(76) Inventor: Malcolm A. Whitaker, Venice, FL (US)

Correspondence Address: MALCOLM A WHITAKER, 222 VENICE PALMS BLVD., VENICE, FL, 34292, US

(21) Appl. No.: 11/290,218

(22) Filed: Dec. 1, 2005

(51) Int. Cl. E06B 1/04

(52) U.S. Cl. 52/204.1

(57) ABSTRACT

A plate of steel, which when cut, bent, shaped, slotted and galvanized becomes a wind-load fastener. The wind-load fastener attaches to the roller track of any new or existing residential overhead garage door. The fasteners are installed, (3) per door jamb track, top, center and bottom, using the imbedded masonry anchor bolt on the wall jamb and the smaller bolt at the track end. When installed, the wind-load is transferred from the wood jamb to the masonry wall.

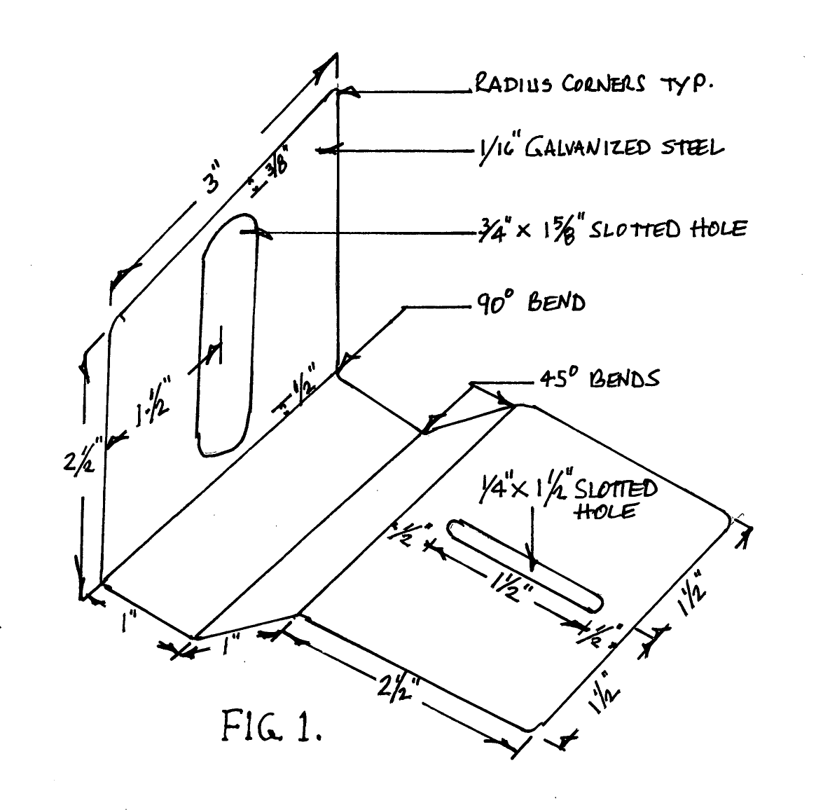

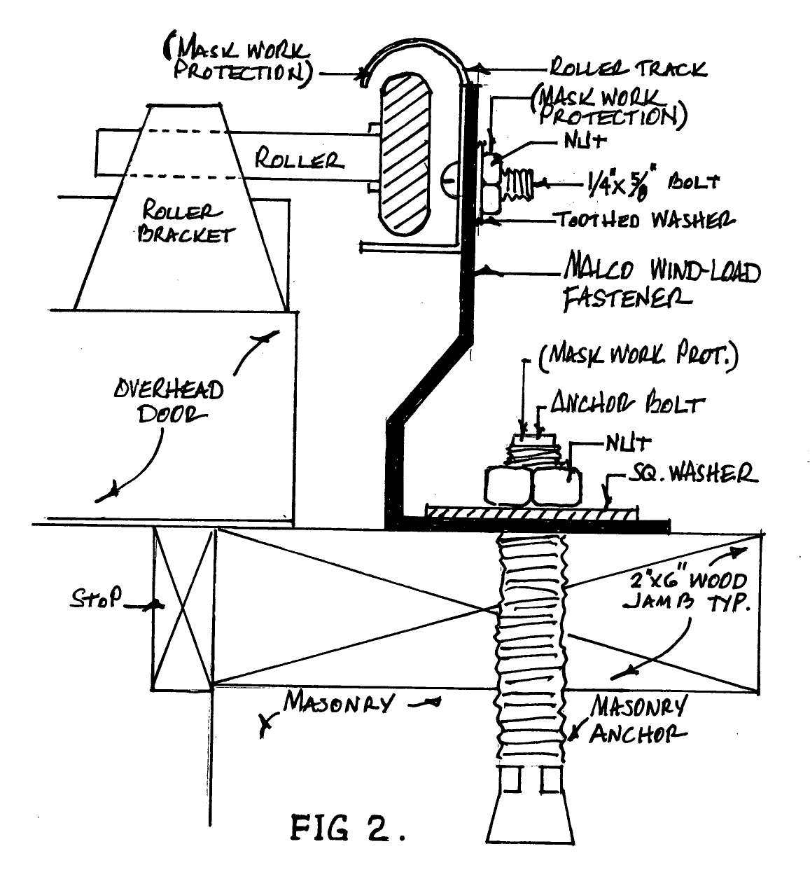

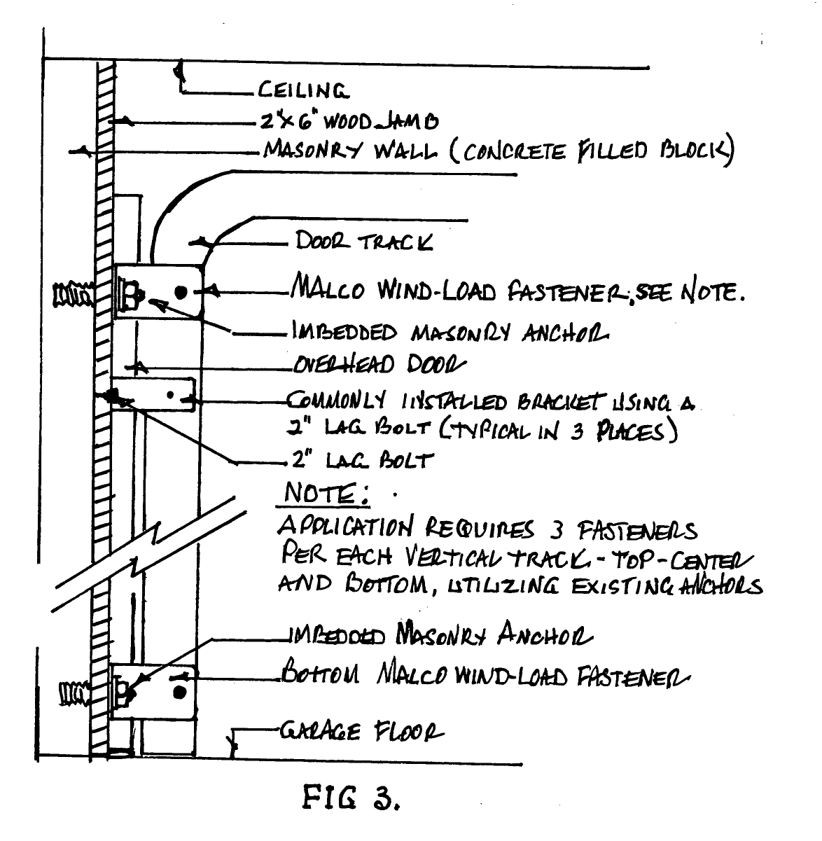

A portion of the disclosure of this document contains material which is subject to {copyright or mask work} protection. The {copyright or mask work} owner has no objection to the facsimile reproduction by anyone of the patent document or the disclosure, as it appears in the Patent and Trademark office patent file or records, but otherwise reserves all {copyright or mask work} rights whatsoever.

### BACKGROUND OF THE INVENTION

The need for a more substantial securing device, at the jamb locations, on residential overhead garage doors, in HIGH WIND or HURRICANE prone areas.

### BRIEF SUMMARY OF THE INVENTION

A device, which when attached to the existing ⅝″ imbedded masonry anchor bolts, as shown on drawings 2 of 3 and 3 of 3, will substantially transfer the wind load from the wood jamb to the masonry structure.

### DESCRIPTION OF THE DRAWINGS

Drawing, 1/3 shows a fastener, made of galvanized steel, 1/16″ in thickness, bent, shaped and slotted to form an adjustable fastener.

Drawing, 2/3 shows the MALCO WIND-LOAD FASTENER, attached to the masonry anchor, using the existing anchor bolt, square washer and nut which affix the wood 2×6″ jamb to the masonry. This drawing also shows the attachment of the MALCO WIND-LOAD FASTENER to the roller track, using a ¼″ ×⅝″ pan head machine bolt, toothed washer,and nut. Please note the “protection disclosure” statement on page one of the specifications.

Drawing 3/3 shows the location and/or arrangement of the WIND-LOAD fasteners on a typical overhead door track, and the weaker lag bolt attachment as customarily installed.

### DETAILED DESCRIPTION OF THE INVENTION

This device (MALCO WIND-LOAD FASTENER), when installed on new or existing installations, as shown on the accompanying drawings, will provide added safety and protection, in HIGH WIND and HURRICANE prone areas. This device will transfer the WIND LOAD from smaller track-attaching lag bolts to the larger imbedded masonry wall anchors. These WIND-LOAD fasteners can be used in conjunction with other strengthening devices such as horizontal or vertical struts. The MALCO WIND-LOAD FASTENER, as shown on the accompanying drawing,1/3, is shaped and slotted in such a fashion that allows it to be adjustable to the variations in the location of the existing masonry bolts. The MALCO WIND-LOAD FASTENERS, when installed, become a permanent part of the track assembly: usually (3) per jamb for doors (7) feet high and (4) per jamb for doors to (8) feet high.

1. I claim the invention, as submitted herewith, to be solely that of my own creation, and being of sane and sound mind, present these drawings, documents, and application papers with all due respect, honesty, and sincerety, claiming and acknowledging this as my own innovation.
